(19) United States
(12) Patent Application Publication
(10) Pub. No.: US 2022/0101246 A1
(43) Pub. Date: Mar. 31, 2022

(54) STOCKTAKING SYSTEM, DATA PROCESSING DEVICE, AND CONTROL METHOD

(71) Applicant: TOSHIBA TEC KABUSHIKI KAISHA, Tokyo (JP)

(72) Inventors: Daiki Joko, Izunokuni Shizuoka (JP); Takuya Haketa, Izunokuni Shizuoka (JP)

(21) Appl. No.: 17/395,237

(22) Filed: Aug. 5, 2021

(30) Foreign Application Priority Data
Sep. 25, 2020 (JP) 2020-160720

(51) Int. Cl. G06Q 10/08

(52) U.S. Cl. CPC G06Q 10/087

(57) ABSTRACT

According to one embodiment, a stocktaking system includes a customer terminal and a store server for tracking commodity inventory at a store. The store server include a processor, a communication interface, and a data storage device. The customer terminal is configured to display a customer stocktaking request button and send a stocktaking request to the store server if the customer presses the stocktaking request button. The processor of the store server is configured to transmit a stocktaking location to the customer terminal in response to the stocktaking request. The customer terminal is configured to indicate the stocktaking location on a touch panel display screen, receive a data input from the customer a indicating the total number of a commodity at the stocktaking location, and then transmit the data input about the total number of the commodity to the store server.

### CROSS-REFERENCE TO RELATED APPLICATION

This application is based upon and claims the benefit of priority from Japanese Patent Application No. 2020-160720, filed Sep. 25, 2020, the entire contents of which are incorporated herein by reference.

### FIELD

Embodiments described herein relate generally to a stocktaking system, a data processing device for stocktaking systems, and a control method of data processing devices for stocktaking systems.

### BACKGROUND

There are shopping support systems by which customers operate shopping support devices in a store's sales areas (e.g., on a sales floor) to read commodity codes (e.g., barcodes or the like) from products to be purchased so that the customers can register products in a sales transaction by themselves.

With such shopping support systems, stores typically lend the terminals that are capable of reading commodity codes to customers as shopping support devices. For example, stores provide such terminals mounted on shopping carts for the customers to use at the store.

In certain newer systems, communication terminals such as smartphones owned by customers themselves can be used as shopping support devices. When communication terminals owned by individuals are used as the shopping support devices, there is the advantage in that initial facility investment can be reduced for stores. For customers, there is also the potential advantage that they can register commodities for purchase by themselves using the same communication terminals in a plurality of different stores, and therefore user operability is good since user familiarity with their own communication terminals will generally be high.

In this way, since purchased commodities can be registered by customers using shopping support devices provided by stores or with those owned by the customers themselves, workloads such as registration of commodities by staff at the stores can be reduced.

On the other hand, such an elimination of store staff may be detrimental with respect to various other purposes and tasks normally provided by store staff such as detection of defective commodities prior to sale, developing an awareness commodity sales trends, stock management of commodities. Typically, work which may be referred to as stocktaking is performed by staff in part to decide commodity exhibition positions, the number of various commodity types to be exhibited on display shelves, and registering the commodity exhibition information in a data processing device for tracking commodity management decisions or the like. The stocktaking work may be referred to in some instances as inventory taking, product inventorying, inventory auditing, or the like. In the stocktaking work, staff scan shelf position codes provided on commodity exhibition shelves (or other product display locations) and then input the displayed number of commodities at the display location using dedicated handheld terminal or the like. The staff may do the stocktaking work over the course of several days in some cases.

### BRIEF DESCRIPTION OF THE DRAWINGS

FIG. 1 is a block diagram illustrating a schematic configuration of a stocktaking system according to an embodiment.

FIG. 2 is a block diagram illustrating a shopping support device.

FIG. 3 is a block diagram of a management server.

FIG. 4 is a schematic diagram illustrating a data structure of a data record included in a member database.

FIG. 5 is a schematic diagram illustrating a data structure of a store data file.

FIG. 6 is a flowchart illustrating aspects of information processing performed by a processor of a shopping support device based on a shopping support application program.

FIG. 7 is a flowchart illustrating aspects of information processing performed by a shopping support device based on the shopping support application program.

FIG. 8 is a flowchart illustrating aspects of information processing performed by a shopping support device based on a shopping support application program.

FIG. 9 is a flowchart illustrating aspects of information processing performed by a shopping support device based on a shopping support application program.

FIG. 10 is a flowchart illustrating aspects of information processing performed by a shopping support device based on a shopping support application program.

FIG. 11 is a flowchart illustrating aspects of a stocktaking start command reception process performed by a management server based on a stocktaking program.

FIG. 12 is a schematic diagram illustrating an example of a check-in screen.

FIG. 13 is a schematic diagram illustrating an example of a camera screen.

FIG. 14 is a schematic diagram illustrating an example of the camera screen.

FIG. 15 is a schematic diagram illustrating an example of a check-in completion screen.

FIG. 16 is a schematic diagram illustrating an example of a registration list screen.

FIG. 17 is a schematic diagram illustrating an example of a shelf instruction screen.

FIG. 18 is a schematic diagram illustrating an example of a shelf position scanning screen.

FIG. 19 is a schematic diagram illustrating an example of a quantity input screen.

FIG. 20 is a schematic diagram illustrating an example of a result screen.

FIG. 21 is a schematic diagram illustrating an example of a registration screen.

FIG. 22 is a schematic diagram illustrating an example of a registration list screen.

FIG. 23 is a schematic diagram illustrating an example of an accounting screen.

FIG. 24 is a schematic diagram illustrating an example of a check-out screen.

### DETAILED DESCRIPTION

An embodiment provides a stocktaking system and a data processing device for reducing a stocktaking workload on a staff of a store.

In general, according to one embodiment, a stocktaking system for tracking inventory at a store includes a customer terminal to be carried by a customer in a store and a store server. The customer terminal includes a first processor, a touch panel display screen, a wireless communication interface, and a camera. The store server includes a second processor, a communication interface configured to communicate with the wireless communication interface, and a data storage device. The first processor is configured to display a customer stocktaking request button on the touch panel display screen, and send a stocktaking request, via the wireless communication interface, to the store server when the customer presses the stocktaking request button. The second processor is configured to transmit a stocktaking location via the communication interface in response to the stocktaking request. The first processor is further configured to receive the stock taking location via the wireless communication interface, indicate the stocktaking location on the touch panel display screen, receive a data input via the camera indicating the total number of a commodity at the stocktaking location, and transmit, via the wireless communication interface, the data input to the store server.

In general, according to one embodiment, a stocktaking system includes a customer terminal operated by a customer in a store and a data processing device for managing commodities of the store. The customer terminal includes announcement means, reception means, and transmission means. The announcement means announces stocktaking of commodities in the store to the data processing device. The reception means receives designation of a commodity exhibition position at which stocktaking is performed from the data processing device. The transmission means receives an input of data related to at least the number of commodities exhibited at the commodity exhibition position and transmits the input data to the data processing device. The data processing device includes designation means and registration means. The designation means designates the commodity exhibition position at which the stocktaking is performed to the customer terminal in response to the announcement from the customer terminal. The registration means receives the data which is transmitted from the customer terminal and is related to at least the number of commodities exhibited at commodity exhibition positions and registers commodity exhibition position information including the data.

According to one embodiment, a data processing device stores a stocktaking program operating if commodities are inventoried. The data processing device includes reception means, determination means, transmission means, and registration means. The reception means receives an announcement about stocktaking of commodities in a store from a staff terminal operated by a staff of the store or a customer terminal operated by a customer in the store. The determination means determines a commodity exhibition position of a commodity at which stocktaking is performed by the customer based on a predetermined condition if the received announcement is an announcement from the customer terminal. The transmission means transmits the determined commodity exhibition position at which the stocktaking is performed to the customer terminal. The registration means receives data which is transmitted from the customer terminal and is related to at least the number of commodities exhibited at the commodity exhibition position and registers commodity exhibition position information including the data.

Hereinafter, certain example embodiments of a stocktaking system will be described with reference to the drawings.

In the example embodiment, communication terminals such as smartphones owned by customers are used as shopping support devices for a stocktaking system that can be introduced in a plurality of stores.

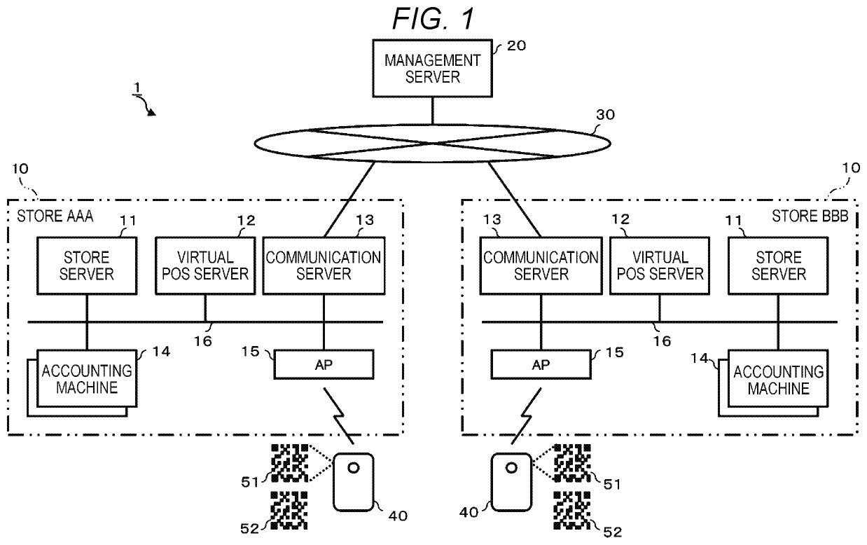

FIG. 1 is a block diagram illustrating a schematic configuration of a stocktaking system 1 according to an embodiment. The stocktaking system 1 includes a plurality of store systems 10, a management server 20, a network 30, and shopping support devices 40.

A store system 10 is configured for each store in which the stocktaking system 1 is introduced. The total number of stores is not particularly limited. In FIG. 1, a store system. 10 in store AAA and a store system 10 in store BBB are illustrated. The company operating store AAA may be the same or different from the company operating store BBB.

The basic configuration of the store system 10 is common to each store. Each store system 10 includes a store server 11, a virtual POS server 12, a communication server 13, an accounting machine 14, and an access point 15 (“AP” in FIG. 1), which are connected via a wired local area network (LAN) 16.

The store server 11 is a computer that supports general store work. To support the general store work, the store server 11 manages various databases including a commodity database. The commodity database is a collection of commodity data records in which data for each commodity sold in a store is described. That is, in the commodity database managed by the store server 11 of store AAA, a commodity data record related to each commodity sold in store AAA is stored. In a commodity database managed by the store server 11 of store BBB, a commodity data record related to each commodity sold in store BBB is stored. The commodity data record includes commodity data such as a commodity code, a price, a commodity name, a commodity image, a shelf position, the number on display, the number in stock, a stocktaking date and time. The commodity code is a unique identification code set for each commodity to identify an individual commodity. Normally, a barcode representing (encoding) a commodity code is attached to each commodity. The shelf position is information for specifying a particular exhibition location (e.g., a product display shelf, display table, or the like) in the store. The shelf position information may include a designation of a particular region of a display location or the like. In an example embodiment, each shelf position is assumed to be a unique identification code set for each commodity exhibition shelf to permit the identification of each individual commodity exhibition shelf at the store. The shelf position may be the position of the exhibition shelf for the commodity as indicated with XY coordinates on an XY plane corresponding to a floor of the store.

The virtual POS server 12 performs processes similar to a standard POS terminal in support of, and in cooperation with, the shopping support device 40. The virtual POS server 12 has a function of registering sales data of a commodity identified by a commodity code input via a particular shopping support device 40. In each shopping support device 40, unique identification information is set to identify each shopping support device. The virtual POS server 12 has a function of generating a registration screen based on the sales data of the commodities registered by the shopping support device 40 and then displaying the registration screen on a display device of the shopping support device 40. The virtual POS server 12 also has a function of generating accounting data based on the sales data of the commodities registered by the shopping support device 40 and then transmitting the accounting data to the store server 11 if transaction settlement accounting is requested from the shopping support device 40.

The communication server 13 supports data communication performed by the management server 20 connected via the network 30.

The accounting machine 14 is a terminal that permits the settlement (payment processing) of purchased commodities. The accounting machine 14 acquires accounting data from the store server 11 and performs settlements based on the accounting data. The settlement scheme is not particularly limited. In the store system 10, a known settlement scheme such as cash settlement, credit card settlement, electronic money settlement, point settlement, or mobile settlement can be used.

The accounting machine 14 may have a function of registering commodities for sale. For example, if a barcode of a commodity is read with a scanner connected to the accounting machine 14, the accounting machine 14 inquires of the store server 11 about the commodity code contained in the barcode. In this inquiry, since commodity data such as a commodity name and a price of a commodity identified with the commodity code is sent from the store server 11, the accounting machine 14 registers sales data of the purchased commodity based on the commodity data. The accounting machine 14 handles settlement of the purchased commodity. Alternatively, the accounting machine 14 adds sales data of the purchased commodity to the accounting data acquired from the store server 11 to perform the settlement.

As the accounting machine 14, there are manned accounting machines for which a salesperson inputs information for settlement and a self-accounting machine (self-service terminal) at which a customer inputs information for settlement. The store system 10 may include both the manned accounting machines and the self-accounting machines or may include just one type. As a manned accounting machine, any known POS terminal can be utilized. As a self-accounting machine, any known self-service type kiosk or semi-self-service type accounting machine can be utilized.

The access point 15 is a communication facility installed in a store as a relay point so each server (the store server 11, the virtual POS server 12, the communication server 13, and the like) of the store system 10 can perform data communication with the shopping support device 40 via a wireless LAN. The wireless LAN conforms with a standard of, for example, Wi-Fi®. In FIG. 1, only one access point 15 is illustrated in a store system 10, but the number of access points 15 is not limited. A plurality of access points 15 may be connected to wired LAN 16 depending on the size or the like of the store.

The management server 20 can be a cloud computing server that provides a service via a communication network such as the Internet. The management server 20 is connected to the communication server 13 of the store system 10 via the network 30. The network 30 is, for example, a wide area network (WAN) in which a virtual private network (VPN) is used. The management server 20 can be connected to the shopping support device 40 via a WAN such as the Internet or a mobile (cellular) communication network. The management server 20 also has a function of relaying data communication with the shopping support device 40 and the store system 10 when in a connected state.

The shopping support device 40 is a portable communication terminal which is used in common if a customer uses the stocktaking system 1 in a plurality of stores. As will be described below in detail, the shopping support device 40 includes hardware reading data codes 51 and 52 of at least a 2-dimensional code system. For example, a smartphone, a tablet terminal, or the like which is commercially available and includes a digital camera can be used as the shopping support device 40. In the embodiment, a communication terminal owned by an individual customer is used as the shopping support device 40.

The data codes 51 and 52 are prepared for each store. The data codes 51 and 52 are prepared at locations at which a customer visiting the store can handle the data codes. Specifically, the data code 51 is prepared at an entrance of each store. The data code 52 is prepared at an exit of each store. Hereinafter, the data code 51 is referred to as entrance data code 51. The data code 52 is referred to as exit data code 52.

Both the entrance data code 51 and the exit data code 52 are codes in which setting information values unique to a store or a company operating the store can be encoded within a predetermined 2-dimensional code system. Some items of the setting information may be common to each store and some items may differ for each store.

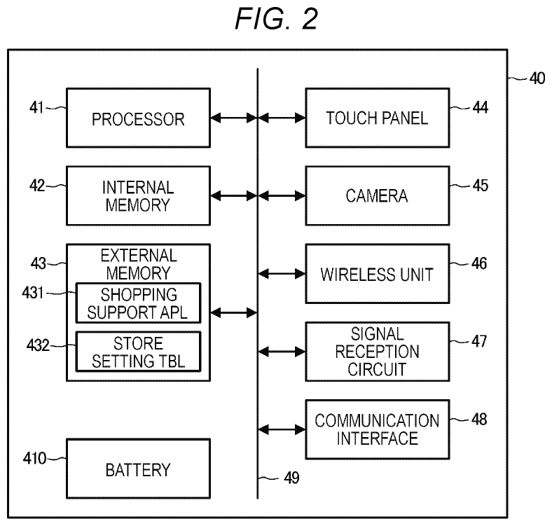

FIG. 2 is a block diagram illustrating a circuit configuration of main units of the shopping support device 40. The shopping support device 40 includes a processor 41, an internal memory 42, an external memory 43, a touch panel 44, a camera 45, a wireless unit 46, a signal reception circuit 47, a communication interface 48, and a system transfer path 49. In the shopping support device 40, a rechargeable type battery 410 is mounted as a driving source.

The system transfer path 49 includes an address bus, a data bus, and a control signal line. In the shopping support device 40, the processor 41, the internal memory 42, the external memory 43, the touch panel 44, the camera 45, the wireless unit 46, the signal reception circuit 47, and the communication interface 48 are connected to the system transfer path 49. In the shopping support device 40, a computer is configured by the processor 41, the internal memory 42, the external memory 43, and the system transfer path 49 connecting them to each other.

The processor 41 corresponds to a central unit of the computer. The processor 41 controls various functions of the shopping support device 40 in accordance with an operating system or an application program. The processor 41 is, for example, a central processing unit (CPU).

The internal memory 42 includes a nonvolatile memory area and a volatile memory area. The internal memory 42 stores the operating system or the application program in the nonvolatile memory area. The internal memory 42 stores data necessary for the processor 41 to perform a process of controlling each unit in the volatile memory area. In the internal memory 42, the volatile memory area is used as a work area in which data can be rewritten appropriately by the processor 41. The nonvolatile memory area is, for example, a read-only memory (ROM). The volatile memory area is, for example, a random access memory (RAM).

The external memory 43 corresponds to an auxiliary storage unit of the computer. For example, an SD memory card or a USB memory can be used as the external memory 43. The external memory 43 stores data which is used for the processor 41 to perform various processes, data which is generated through a process by the processor 41, and the like. The external memory 43 stores an application program in some cases.

The touch panel 44 is a device that serves as both an input device and a display device of the shopping support device 40. The touch panel 44 detects a touched position on a displayed image and outputs touched position information to the processor 41.

The camera 45 is an imaging device embedded in the shopping support device 40. The camera 45 operates as an imaging device for acquiring a still image or a moving image in accordance with an application program installed in the shopping support device 40. The camera 45 also operates as scanning device for acquiring a data code such as a 2-dimensional code or a barcode. The camera 45 is one example of a code reader.

The wireless unit 46 is a circuit that performs data communication with the access point 15 in conformity with a communication protocol of a wireless LAN.

The signal reception circuit 47 receives a beacon signal transmitted from a beacon transmitter. The beacon transmitter is a device that periodically transmits a signal (called a beacon or a beacon signal) using a short-range wireless technology such as Bluetooth®. In a store, many beacon transmitters can be distributed and disposed in various locations. A beacon signal including information for specifying an installation location of the beacon transmitter can be continuously transmitted from each beacon transmitter. The processor 41 of the shopping support device 40 can recognize the current location of the shopping support device 40 within the store in accordance with the information included in the beacon signal (s) received by the signal reception circuit 47. The shopping support device 40 includes a recognition unit that recognizes the current location in accordance with the beacon signal(s) received by the signal reception circuit 47.

The communication interface 48 is a circuit that performs data communication with the management server 20 connected via the Internet or a mobile communication network.

In the shopping support device 40, a shopping support application program 431 (abbreviated “APL” in FIG. 2) is stored in the external memory 43. The shopping support application program 431 is an application program that causes a communication terminal owned by an individual to function as the shopping support device 40. If the shopping support application program 431 is installed in a communication terminal, the communication terminal functions as the shopping support device 40.

If the shopping support application program 431 is installed, a store setting table 432 (“TBL” in FIG. 2) is formed in the external memory 43. In the store setting table 432 of this example, only intended setting values (parameters) are described and actual setting values are not included. The setting value for each item is encoded in the entrance data code 51 and the exit data code 52. That is, if the entrance data code 51 is read with the camera 45, the setting values for the store setting table 432 for the read item are provided for the shopping support device 40.

The store setting table 432 includes information for identifying the store in which a customer is shopping using the shopping support device 40 in addition to an operating version number or the like for the shopping support application program 431. That is, the entrance data code 51 and the exit data code 52 include information for identifying the store in which the customer is shopping 0. Such kinds of identifying information can be setting information unique to the store. The information for identifying the store can include, for example, a company code, a store code, a company name, and/or a store name.

Here, the company code is a code for identifying a company that operates the store. The store code is a code for identifying the store. The company name is the name of the company that operates the store. The store name is the name of the particular store.

The store setting table 432 can also include an entrance flag entry. The entrance flag is for identifying whether an acquisition source of the setting values, that is, the read data code, is an entrance data code 51 or an exit data code 52.

The store setting table 432 can include parameters (e.g., network settings or the like) necessary for the shopping support device 40 to perform communication at the store. That is, the entrance data code 51 and the exit data code 52 include parameters necessary for the shopping support device 40 to perform communication. Such kinds of parameters can be setting information unique to the store. Such parameters can include, for example, an IP address, a cloud domain name, an electronic receipt server address, an in-store LAN flag, an in-store LAN SSID, an in-store LAN password, an in-store LAN security scheme, a cloud requisite flag, a status transmission mode, a log transmission mode, an FTP host name, an FTP user name, an FTP password, an FTP log folder path.

In this context, the IP address value is an IP address of the communication server 13 included in the store. The cloud domain name value is a domain name of the management server 20. The electronic receipt server address value is a network address of an electronic receipt server used by the store. The in-store LAN flag is a flag value indicating whether an in-store LAN is used. The in-store LAN SSID is a service set identifier (SSID) of the access point 15 installed at the store. The in-store LAN password is a password set for the in-store LAN of the store. The in-store LAN security scheme indicates an encryption key for a security scheme (WPA2-PSK, WPA-PSK, WEP, or the like) set in the in-store LAN for the store. The cloud requisite flag is a flag value for identifying whether an error state is determined or the use continues without determining an error state if the shopping support device 40 fails to connect with the management server 20. The status transmission mode value indicates a mode by which a status of the shopping support device 40 is transmitted to the management server 20, a mode by which the status is transmitted to the store system 10, and a mode by which the status is not transmitted. The log transmission mode value indicates a mode in which a log file in which log data of the shopping support device 40 is accumulated is transmitted to only the management server 20, a mode in which the log file is transmitted to only the store system 10, a mode in which the log file is transmitted to both the management server 20 and the store system 10, and a mode in which the log file is not transmitted. The FTP host name is a host name or an IP address used to transmit the log file to the management server 20. The FTP user name is a user name in the protocol used to transmit the log file to the management server 20. The FTP password is a password used to transmit the log file to the management server 20. The FTP log folder path is a path name of the log file transmitted to the management server 20 via the Internet.

The store setting table 432 includes operation restriction information for the store when the shopping support device 40 is used in the store. That is, the entrance data code 51 and the exit data code 52 include operation restriction information for the store for the shopping support device 40. The operation restriction information can be setting information unique to the store. The operation restriction information can include a UPC check digit deletion flag, a camera auto-transition time, a mobile communication timeout time, the number of mobile communication retries, a cloud communication timeout time, the number of cloud communication retries, a salesperson check warning cancellation barcode value, an operation mode, an accounting machine transmission mode, a mobile settlement flag, a 20-unallowable (restricted) commodity forcing mode, a points card input mode, an authority mode flag, and a battery check threshold.

In this context, the UPC check digit deletion flag is for identifying whether to delete a check digit of a universal product code (UPC) code, which is one kind of commodity code. The camera auto-transition time is an automatic transition time for the camera 45 included in the shopping support device 40. The mobile communication timeout time is the timeout time when the shopping support device 40 communicates with the store system 10 via a wireless LAN. The number of mobile communication retries is the number of retries at the time of checkout when the shopping support device 40 communicates with the store system 10 via the wireless LAN. The cloud communication timeout time is a timeout time when the shopping support device 40 communicates with the store system 10 via the management server 20. The number of cloud communication retries is the number of retires at the time of checkout when the shopping support device 40 communicates with the store system 10 via the management server 20. The salesperson check warning cancellation barcode value indicates whether a salesperson check is required for a scanned product is required such as a check by a salesperson who checks an age of a customer if the customer purchases certain age-controlled items (referred to as “a 20-unallowable commodity”) such as an alcoholic drink or a cigarette.

The operation modes include a normal mode in which the stocktaking system 1 is operated normally and a demonstration mode in which the stocktaking system 1 is operated only as a demonstration. The accounting machine transmission modes include a mode in which an accounting barcode is used and a mode in which an accounting barcode is not used. In the store system 10, sales data of a commodity from which a customer reads a commodity code using the shopping support device 40 is registered in the virtual POS server 12 as a commodity being purchased. If the customer gives an instruction from the shopping support device 40 to pay or settle the purchased commodity, accounting data generated based on the sales data of the purchased commodity registered in the virtual POS server 12 is transmitted to the accounting machine 14 via the store server 11. At this time, a mode in which the accounting data is transmitted to the accounting machine 14 includes a mode in which an accounting barcode associated with the accounting data is used and a mode in which the accounting barcode is not used.

The mobile settlement flag is for identifying whether mobile settlement is adopted. As one price settlement scheme for the purchased commodity, there is mobile settlement. The mobile settlement is a scheme of paying a price of a commodity using a barcode or a 2-dimensional code electronically using the shopping support device 40. The 20-unallowable commodity forcing flag is for identifying whether a commodity (such as an alcoholic drink or a cigarette) for which an age restriction is set, is permitted to be registered by the shopping support device 40. The points card input mode provides a mode in which a card number of a points card (e.g., a customer loyalty program membership card) can be input manually and a mode in which a data code printed on a card can be read with the camera 45. The authority mode flag is a flag for identifying whether the control mode is set to a mode for shopping support in a store or a mode for a sales transaction limited to an operation of an authority. For example, a sales transaction for inputting the card number of a points card is not allowed to be performed by a customer. This sales transaction is allowed to be performed only by an authority of the store (e.g., an authorized employee). Therefore, the shopping support device 40 has a mode for shopping support of a store and a mode for a sales transaction limited to an operation of the authority as control modes. The battery check threshold is a threshold of a battery capacity set for each store or company so that a battery of the shopping support device 40 does not run out during shopping.

The method of installing a control program, such as the shopping support application program 431, in the external memory 43 is not particularly limited. The control program can be recorded on a removable recording medium or the control program can be delivered through communication via a network then installed in the external memory 43. The type of recording medium does not matter as long a program can be stored and can be read by a device as in an SD memory card or a USB memory. The installation destination of the control program is not limited to the external memory 43. The control program may be installed in the internal memory 42.

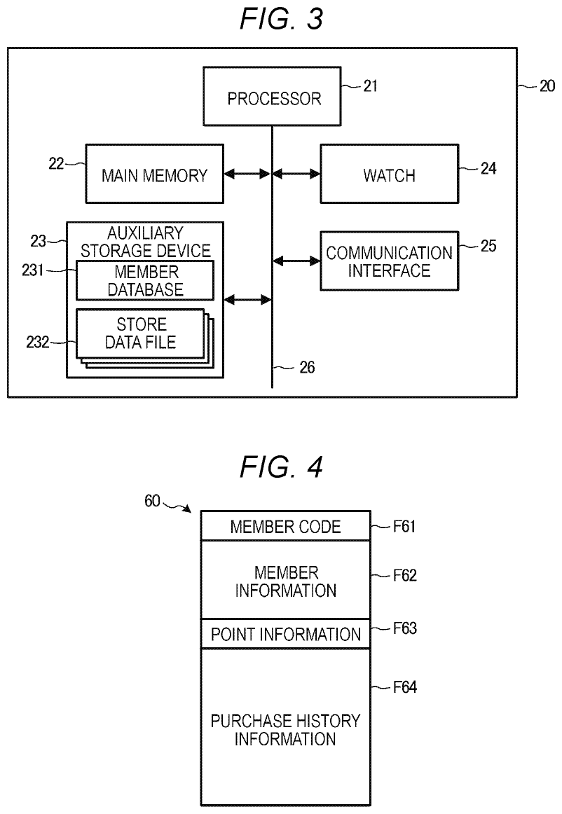

FIG. 3 is a block diagram illustrating a configuration of the management server 20 according to an embodiment. The management server 20 includes a processor 21, a main memory 22, an auxiliary storage device 23, a watch 24, a communication interface 25, and a system transfer path 26. The system transfer path 26 includes an address bus, a data bus, and a control signal line. In the management server 20, the processor 21, the main memory 22, the auxiliary storage device 23, the watch 24, and the communication interface 25 are connected to the system transfer path 26. In the management server 20, a computer is configured by the processor 21, the main memory 22, the auxiliary storage device 23, and the system transfer path 26 connecting them to each other.

The processor 21 corresponds to a central unit of the computer. The processor 21 controls each unit such that various functions of the management server 20 can be realized in accordance with an operating system or an application program. The processor 21 is, for example, a CPU.

The main memory 22 includes a nonvolatile memory area and a volatile memory area. The main memory 22 stores the operating system or the application program in the nonvolatile memory area. The main memory 22 stores data necessary for the processor 21 to perform a process of controlling each unit in the volatile memory area. The data is also stored in a nonvolatile memory area in some cases. In the main memory 22, the volatile memory area is used as a work area in which data can be rewritten appropriately by the processor 21. The nonvolatile memory area is, for example, a ROM. The volatile memory area is, for example, a RAM.

An EEPROM, an HDD, or an SSD can be used as the auxiliary storage device 23. The auxiliary storage device 23 stores data which is used for the processor 21 to perform various processes, data which is generated through a process of the processor 21, and the like. The auxiliary storage device 23 can stores an application program in some cases.

An application program stored in the main memory 22 or the auxiliary storage device 23 may include a control program such as a stocktaking program in which information processing performed by the management server 20 is described. As in the case of the shopping support application program 431, the method of installing a control program in the main memory 22 or the auxiliary storage device 23 is not particularly limited.

The watch 24 tracks or otherwise provides a date and time. The management server 20 acquires a current date and time from the watch 24.

The communication interface 25 is a circuit that transmits and receives data to and from the communication server 13 of each store system 10 connected via the network 30 in conformity with a predetermined communication protocol.

In the management server 20 that has the configuration, a member database 231 and a store data file 232 are stored in the auxiliary storage device 23. In FIG. 3, a database is abbreviated to DB. The store data file 232 is prepared for each store. A storage destination of the member database 231 and/or the store data file 232 is not limited to the auxiliary storage device 23. The member database 231 and/or the store data file 232 may be stored in the volatile memory area of the main memory 22.

FIG. 4 is a schematic diagram illustrating a data structure of a data record 60 included in the member database 231. The member database 231 is a database for managing members of the stocktaking system 1 and is a collection of data records associated with registered members. Therefore, the member database 231 includes the number of data records 60 corresponding to the number of registered members. The data record 60 includes fields F61, F62, F63, and F64.

In the field F61, a member code for distinguishing a related customer from other customers is set. The member code is, for example, a unique identification code set for each customer to distinguish an individual member of the stocktaking system 1. For example, the member code can be set to a card number of a points card. Alternatively, as the member code, for example, an identification code set in the shopping support application program 431 in installation of the shopping support application program 431 in the shopping support device 40 can be used.

In the field F62, member information which is attribute information regarding a customer specified with the member code is set. The member information can include a name, a gender, an age, an address, a telephone number, and an electronic mail address. The member information may include settlement method information reported by a requester. The settlement method information is a credit card number, a code settlement identifier (ID), or the like. When a plurality of settlement methods can be selected, the settlement method information also includes a settlement method code for identifying a settlement method.

In the field F63, coupon information is set indicating a benefit granted to an associated customer. The coupon information can include a member ID of a points service and the number of possessed points.

In the field F64, purchase history information of an associated customer is set. That is, a history indicating when, at which store, and which commodities a customer purchases is stored in the field F64.

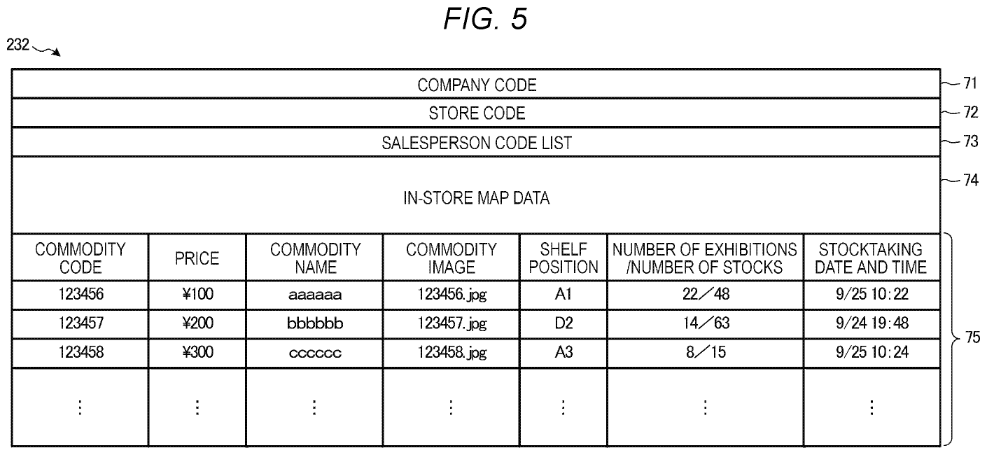

FIG. 5 is a schematic diagram illustrating a data structure of the store data file 232. The store data file 232 includes a region 71 for describing a company code, a region 72 for describing a store code, a region 73 for describing a list of salesperson codes indicating sales persons of a store, and a region 74 for describing in-store map data, and a region 75 for describing a plurality of pieces of commodity data. In the regions 71 and 72, a company code of a company operating a store and a store code of the store are described. That is, in the store data file 232 for store AAA, a company code of a company operating store AAA and a store code are described in the regions 71 and 72. In the store data file 232 for store BBB, a company code of a company operating store BBB and a store code are described in the regions 71 and 72.

In the region 74, data for an in-store map image showing layouts of commodity exhibition shelves, registers, service counters, and the like in a store are stored. That is, in the store data file 232 for store AAA, an in-store map image of store AAA is described. In the store data file 232 for store BBB, an in-store map image of store BBB is described.

In the region 75, commodity codes, prices, commodity names, commodity images, shelf positions, the number on display (e.g., the number of items on a display shelf or the like) and the number in stock (e.g., total number of an item at store whether presently on display or not), stocktaking dates and times of commodities sold in a store are described. The information can be synchronized to a commodity database managed by the store server 11. That is, in the store data file 232 for store AAA, commodity codes, prices, and the like of all the commodities sold in store AAA are stored. In the store data file 232 for store BBB, commodity codes, prices, and the like of all the commodities sold in store BBB are stored.

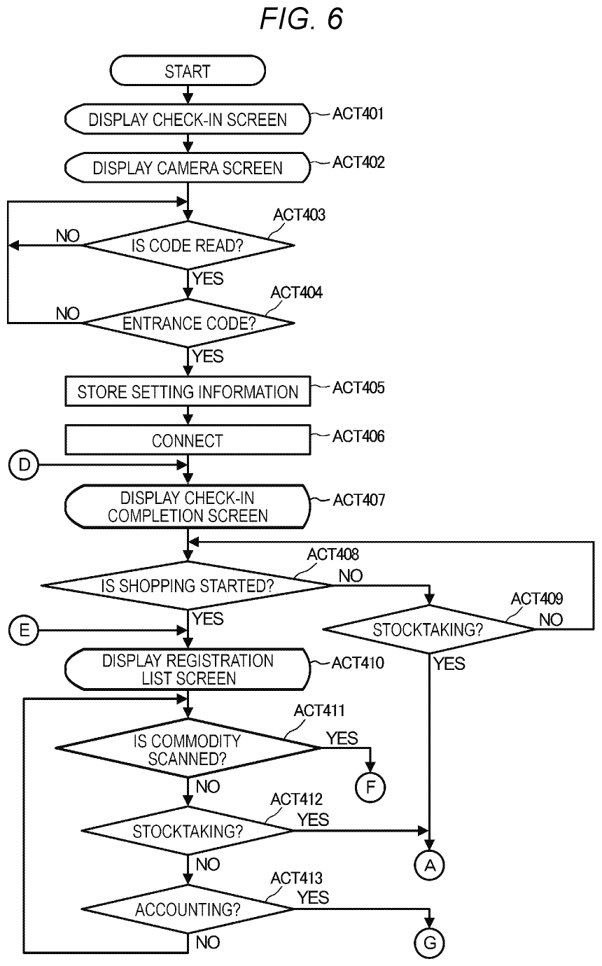

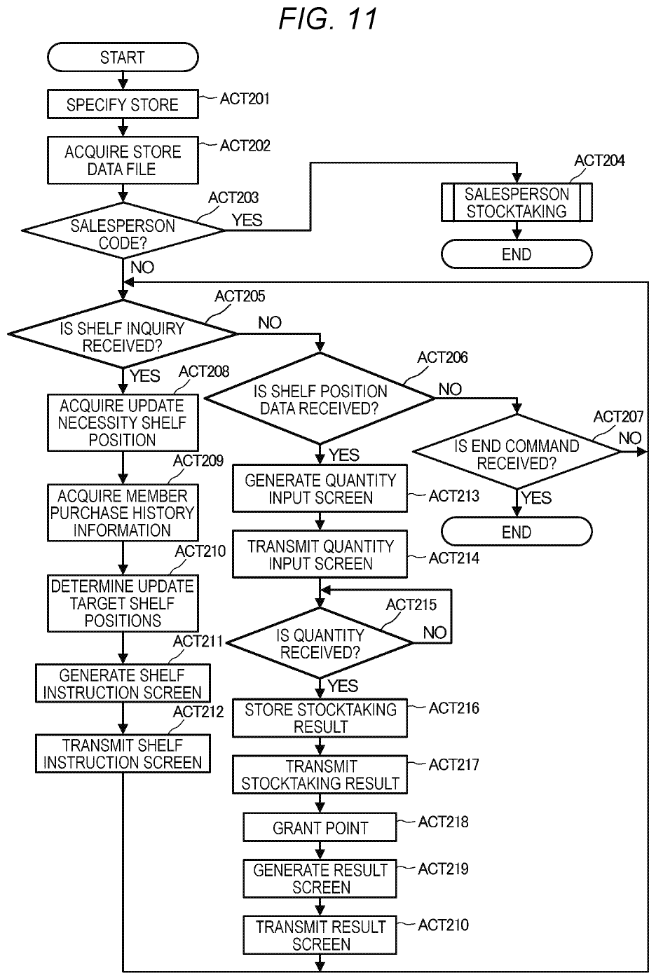

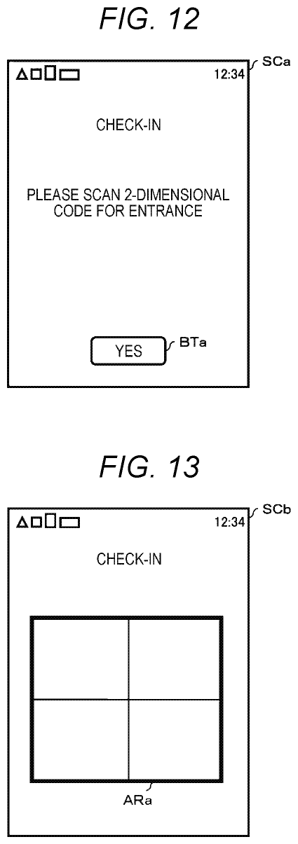

FIG. 6 to FIG. 10 are flowcharts of information processing performed by the processor 41 based on the shopping support application program 431. FIG. 11 is a flowchart illustrating of a stocktaking start command reception process performed after reception of a stocktaking start command from the shopping support device 40 by the processor 21 of the management server 20. FIGS. 12 to 24 are schematic diagrams illustrating examples of various screens displayed on the touch panel 44 of the shopping support device 40. Hereinafter, certain operations of the stocktaking system 1 will be described with reference to these drawings. Contents of the operations to be described below are for purposes of explanation of certain technical concepts. The present disclosure is not limited to the example operation procedures and contents.

In the example, a customer goes to a store at which the stocktaking system 1 has been introduced. The customer then activates the shopping support application program 431 of a shopping support device 40 as the customer enters the store. Then, the processor 41 begins information processing according to the procedures in the flowcharts of FIGS. 6 to 10.

Once the shopping support application program 431 is activated, in ACT 401 the processor 41 displays a check-in screen on touch panel 44.

FIG. 12 illustrates an example of a check-in screen SCa. On the check-in screen SCa, as illustrated, an image of a “YES” button BTa for requesting a customer to confirm a displayed message is displayed along with the message instructing the customer to scan a 2-dimensional code for entrance. The customer touches the “YES” button BTa for confirming check-in is wanted.

If it is detected that the “YES” button BTa on the check-in screen SCa is touched by a signal from the touch panel 44, the processor 41 activates the camera 45 and displays a camera screen on the touch panel 44 for ACT 402.

FIG. 13 illustrates an example of a camera screen SCb. On the camera screen SCb, an image indicating a reading region ARa for a 2-dimensional code is displayed. The customer holds up the lens of the camera 45 embedded in the shopping support device 40 to an entrance data code 51 pre-located at an entrance of the store. The customer manipulates the shopping support device 40 so that the entrance data code 51 fits within the reading region ARa.

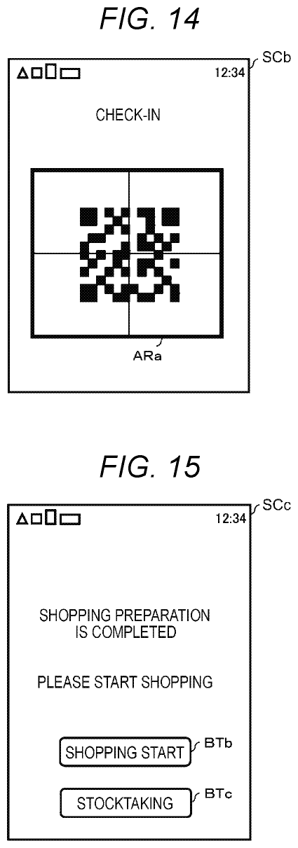

In ACT 403, the processor 41 displaying the camera screen SCb waits for reading a 2-dimensional code by the camera 45. As illustrated in FIG. 14, once the 2-dimensional code fits within the reading region ARa, the processor 41 identifies that the code has been read. If the processor 41 determines YES in ACT 403, the process proceeds to ACT 404.

In ACT 404, the processor 41 analyzes (decodes) the encoded data in an image of the 2-dimensional code from the camera 45 and to confirm whether the read code is an entrance data code 51. If the entrance data code 51 has been read, the processor 41 determines YES in ACT 404. However, if the customer mistakenly performs reading of an exit data code 52 or the like, the processor 41 determines NO in ACT 404.

If the processor 41 determines NO in ACT 404, the process returns to ACT 403. That is, the processor 41 waits for reading of another 2-dimensional code by the camera 45.

If the processor 41 determines YES in ACT 404, the process proceeds to ACT 405. In ACT 405, the processor 41 stores, in the store setting table 432, various kinds of setting information which were encoded in the entrance data code 51.

In this way, the processor 41 begins an entrance operation for a particular store and acquires the setting information which may be unique to the store by use of the camera 45. The processor 41 stores the acquired setting information for the store in the store setting table 432.

Thereafter, in ACT 406, the processor 41 controls the wireless unit 46 in accordance with setting information stored in the store setting table 432 for establishing a connection to an in-store LAN such that a connection to the in-store LAN is made.

Before making a connection to the in-store LAN, it is preferable to check a remaining capacity of the battery 410 of the shopping support device 40. By such a check, it is possible to prevent the battery of the shopping support device 40 from running out during shopping. If the remaining capacity of the battery 410 is too small, the customer may be requested to charge the shopping support device 40 or connect an externally attached battery and activate the shopping support application program 431 again.

If it is confirmed that the shopping support device 40 is connected to the in-store LAN, the processor 41 displays a check-in completion screen on the touch panel 44 in ACT 407.

FIG. 15 illustrates an example of a check-in completion screen SCc. On the check-in completion screen SCc, as illustrated, images of a “shopping start” button BTb and a “stocktaking” button BTc are displayed along with a message indicating that shopping can begin.

The customer confirming the check-in completion screen SCc touches the “shopping start” button BTb or the “stocktaking” button BTc. In this example, the customer wants to cooperate in stocktaking so touches the “stocktaking” button BTc. Any customer wishing only to shop touches the “shopping start” button BTb.

Once the shopping support device 40 is connected to the in-store LAN, the store server 11 of the store system 10 acquires an identification code of the shopping support application program 431 from the shopping support device 40. The store server 11 may also acquire various kinds of data about the shopping support device 40 from store setting table 432. For example, the store server 11 acquires a “company code” and a “store code” from the store setting table 432. The store server 11 confirms whether the company code and the store code already set in advance for the store server 11 match the data of the “company code” and the “store code” acquired from the shopping support device 40. If the set company code and the set store code match the data of the “company code” and the “store code,” the store server 11 notifies the virtual POS server 12 of the identification code of the shopping support application program 431. The virtual POS server 12 generates a commodity registration table in which the identification code of the shopping support application program 431 of which the store server 11 notifies is set. The store server 11 wirelessly transmits a check-in completion command to the shopping support device 40. Upon receiving the check-in completion command, the processor 41 of the shopping support device 40 displays the check-in completion screen SCc on the touch panel 44.

The processor 41 checks whether the “shopping start” button BTb is touched in ACT 408. If the “shopping start” button BTb is not touched, the processor 41 determines NO in ACT 408 and the process proceeds to ACT 409. In ACT 409, the processor 41 checks whether the “stocktaking” button BTc is touched. If the “stocktaking” button BTc is not touched, the processor 41 determines NO in ACT 409 and the process returns to ACT 408. Here, in ACT 408 and ACT 409, the processor 41 waits for a touch of the “shopping start” button BTb or a touch of the “stocktaking” button BTc.

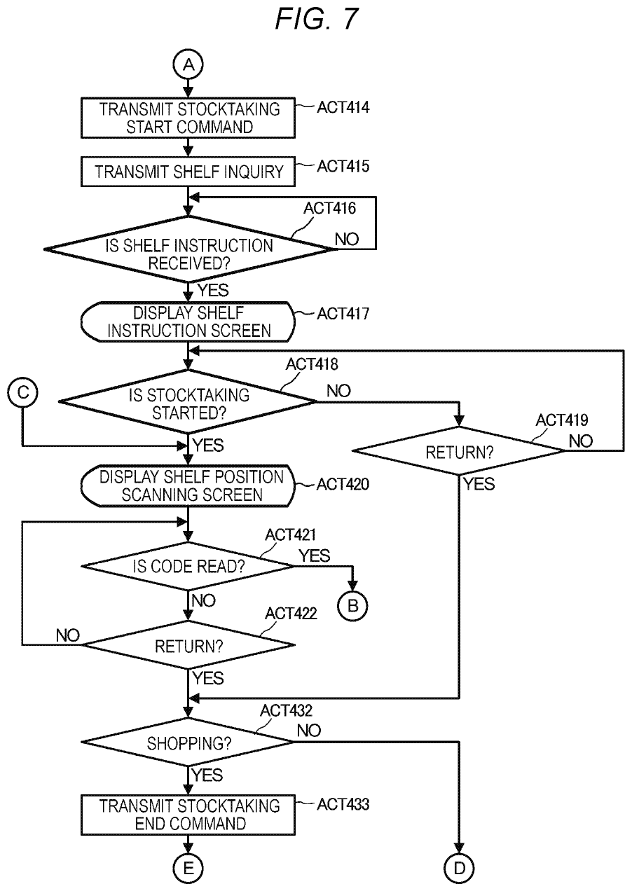

If the “stocktaking” button BTc is touched, the processor 41 determines YES in ACT 409 and the process proceeds to ACT 414 in FIG. 7.

If the “shopping start” button BTb is touched in the waiting state of ACT 408 and ACT 409, the processor 41 determines YES in ACT 408 and the process proceeds to ACT 410. In ACT 410, the processor 41 displays a registration list screen on the touch panel 44.

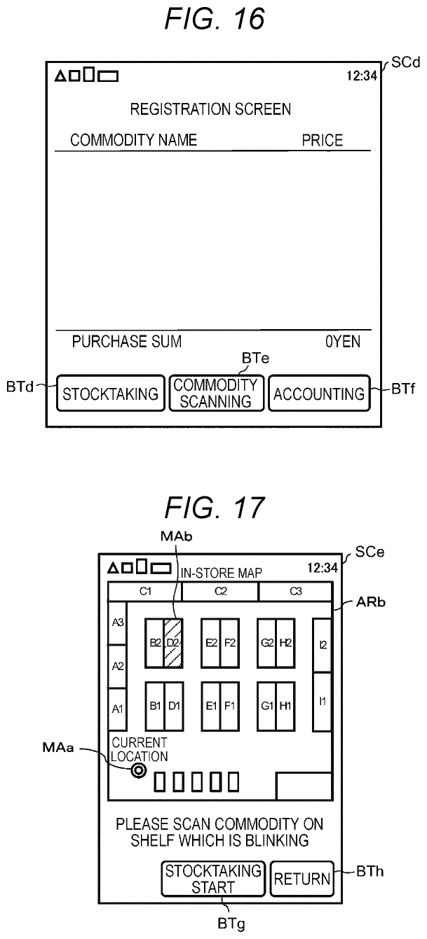

FIG. 16 illustrates an example of a registration list screen SCd. On the registration list screen SCd, as illustrated, a region for displaying commodity names, prices, and a purchase sum of purchased commodities is formed. Images of a “stocktaking” button BTd, a “commodity scanning” button BTe, and an “accounting” button BTf are displayed.

In ACT 411, the processor 41 displaying the registration list screen SCd confirms whether the “commodity scanning” button BTe is touched. If the “commodity scanning” button BTe is not touched, the processor 41 determines NO in ACT 411 and the process proceeds to ACT 412. In ACT 412, the processor 41 confirms whether the “stocktaking” button BTd is touched. If the “stocktaking” button BTd is not touched, the processor 41 determines NO in ACT 412 and the process proceeds to ACT 413. In ACT 413, the processor 41 confirms whether the “accounting” button BTf is touched. If the “accounting” button BTf is not touched, the processor 41 determines NO in ACT 413 and the process returns to ACT 411. Here, the processor 41 waits for a touch of the “commodity scanning” button BTe, a touch of the “stocktaking” button BTd, or a touch of the “accounting” button BTf in ACT 411 to ACT 413.

The customer starting shopping touches the “commodity scanning” button BTe to scan barcodes attached to purchased commodities if the customer puts the purchased commodities in a container such as a shopping basket or a shopping cart. If the customer finishes the shopping, the customer touches the “accounting” button BTf. If the customer sees a notice in the store or hears an announcement broadcast in the store during shopping, then customer may know that points usable for payment can be granted if the customer cooperates in the stocktaking process, and thus may take up a notion of cooperating in the stocktaking process in some cases. In these cases, the customer would touch the “stocktaking” button BTd.

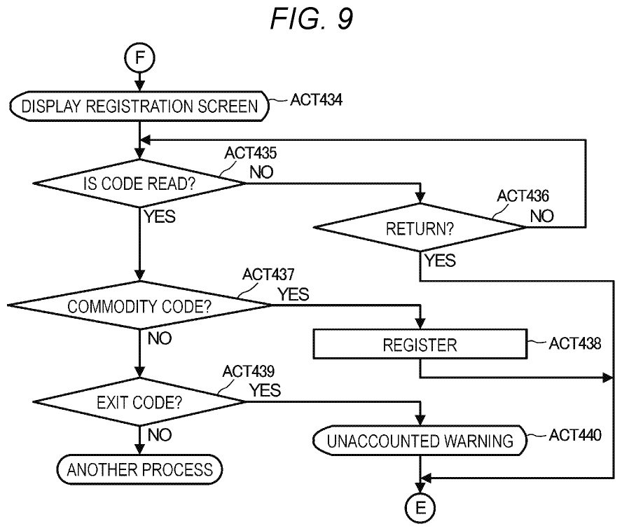

If the “commodity scanning” button BTe is touched in the waiting state of ACT 411 to ACT 413, the processor 41 determines YES in ACT 411 and the process proceeds to ACT 434 of FIG. 9.

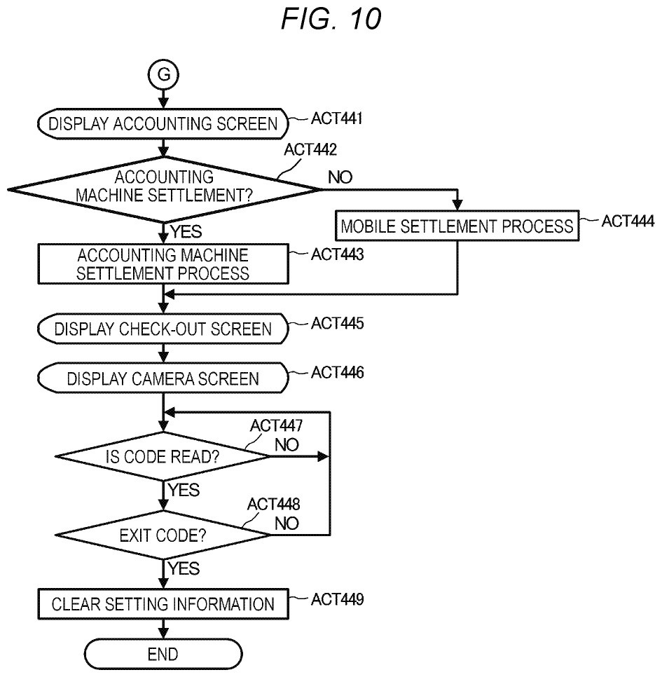

If the “accounting” button BTf is touched in the waiting state of ACT 411 to ACT 413, the processor 41 determines YES in ACT 413 and the process proceeds to ACT 441 of FIG. 10.

If the “stocktaking” button BTd is touched in the waiting state of ACT 411 to ACT 413, the processor 41 determines YES in ACT 412 and the process proceeds to ACT 414 of FIG. 7.

In ACT 414, the processor 41 transmits a stocktaking start command to the management server 20. For example, the processor 41 transmits the stocktaking start command to the management server 20 using a parameter set in the store setting table 432 via the in-store LAN and the communication server 13 of the store system 10 by the wireless unit 46. Alternatively, the processor 41 transmits the stocktaking start command to the management server 20 using a parameter set in the store setting table 432 via the Internet by the communication interface 48. The stocktaking start command includes a member code for specifying a customer using the shopping support application program 431 as a person-in-charge code of a person in charge of stocktaking and includes a company code and a store code set in the store setting table 432.

An operation of the management server 20 receiving the stocktaking start command will be described with reference to the flowchart of FIG. 11. If the processor 21 of the management server 20 receives the stocktaking start command, a process of a procedure in the flowchart of FIG. 11 starts.

In ACT 201, the processor 21 first specifies a store of a data transmission source by detecting a company code and a store code from the stocktaking start command. In ACT 202, the processor 21 acquires the store data file 232 in which the company code and the store code are described in the regions 71 and 72. Hereinafter, the acquired store data file 232 is referred to as a target store data file 232.

In ACT 203, the processor 21 detects the person-in-charge code from the stocktaking start command and determines whether the person-in-charge code is a store code. That is, the processor 21 determines whether the detected person-in-charge code is on the store code list described in the region 73 of the target store data file 232. If the detected person-in-charge code is on the store code list, the processor 21 determines YES in ACT 203 and the process proceeds to ACT 204.

In ACT 204, the processor 21 performs a known salesperson stocktaking process by a dedicated handy terminal operated by a salesperson. Then, the process ends in response to reception of the stocktaking start command.

Conversely, if the detected person-in-charge code is not on the store code list, the processor 21 determines NO in ACT 203 and the process proceeds to ACT 205.

In ACT 205, the processor 21 confirms whether a shelf inquiry is received. If the shelf inquiry is not received, the processor 41 determines NO in ACT 205 and the process proceeds to ACT 206. In ACT 206, the processor 41 confirms whether shelf position data is received. If the shelf position data is not received, the processor 41 determines NO in ACT 206 and the process proceeds to ACT 207. In Act 207, the processor 41 confirms whether the stocktaking end command is received. If the stocktaking end command is not received, the processor 41 determines NO in ACT 207 and the process returns to ACT 205. Here, the processor 41 waits for reception of a subsequent instruction in ACT 205 to ACT 207.

FIG. 7 is referred to back for description. In ACT 415, the processor 41 of the shopping support device 40 transmitting the stocktaking start command transmits a shelf inquiry to inquire of the management server 20 about a shelf in which stocktaking is performed. In ACT 416, the processor 41 waits for reception of a shelf instruction screen as response data from the management server 20.

If the processor 21 of the management server 20 receives a shelf inquiry after the subsequent processing of ACT 205 to ACT 207 is completed, the processor 21 determines YES in ACT 205 and the process proceeds to ACT 208.

In ACT 208, the processor 21 acquires an update necessity for a shelf position (which is the position of a commodity exhibition shelf) on which the commodities which are to be stocked are to be exhibited. That is, the processor 21 first specifies the commodities which are considered to need to be (re)stocked based on the last stocktaking date and time in the data of each commodity described in the region 75 of the target store data file 232. For example, the processor 21, using the present date and time from the watch 24, specifies commodities for which a predetermined time, such as 24 hours, has passed since the last recorded stocktaking date and time. The processor 21 then acquires the shelf position for such commodities as the update necessity shelf position.

Subsequently, in ACT 209, the processor 21 acquires member purchase history information, which is commodity purchase history information of customers which will be doing the stocking. That is, the processor 21 retrieves the member database 231 using a member code included as the person-in-charge code in the stocktaking start command and reads the purchase history information stored in the field F64 of the data record 60 associated with the customer.

In ACT 210, the processor 21 selects the update target shelf positions at which targeted customers are requested to perform stocktaking by narrowing down the acquired update necessity shelf positions based on the acquired member purchase history information. For example, if there are shelf positions in the acquired update necessity shelf positions corresponding to commodities of a type that were purchased previously by a targeted customer (or customers), the processor 21 selects these shelf positions as the update target shelf positions for the customer (s). If there are no shelf positions corresponding to previously purchased commodities of the targeted customer in the acquired update necessity shelf positions, then shelf positions near the shelf positions corresponding to the previously purchased commodities can be selected as the update target shelf positions for the customer. In this way, for the customers performing the stocktaking, the shelf positions corresponding to previously purchased commodities or relatively nearby positions are designated as the stocktaking positions, and thus it can be assumed to be easier for such customers to find the designated shelf positions for the stocktaking. For the store, the customers go to commodity display shelves at which previously purchased commodities are displayed or otherwise nearby to such commodity display shelves, and thus the customers might be motivated to repurchase their certain commodities since the customers will stay near the display positions of their previously purchased commodity types, which can lead to sales promotion after the stocktaking work ends.

In ACT 211, the processor 21 generates a shelf instruction screen based on the in-store map data described in the region 74 of the target store data file 232 and the determined update target shelf position. In ACT 212, the processor 21 transmits the generated shelf instruction screen to the shopping support device 40 which is a stocktaking start command transmission source. Thereafter, the processor 21 returns the waiting steps of ACT 205 to ACT 207.

If the processor 41 of the shopping support device 40 receives the shelf instruction screen in the reception waiting state of the shelf instruction screen of ACT 416 illustrated in FIG. 7, the processor 41 determines YES in ACT 416 and the process proceeds to ACT 417. In ACT 417, the processor 41 displays the received shelf instruction screen on the touch panel 44.

FIG. 17 illustrates an example of a shelf instruction screen SCe. On the shelf instruction screen SCe, as illustrated, the in-store map image ARb corresponding to the in-store map data is displayed. In the in-store map image ARb, an image portion corresponding to a shelf position at which stocktaking is to be performed is displayed in an emphasis manner such as blinking display of a scan shelf position mark MAb, display of a specific color such as red, or special background display such as hatching or shading. On the shelf instruction screen SCe, images of a “stocktaking start” button BTg and a “return” button BTh are displayed.

The processor 41 recognizes a current location in accordance with information included in a beacon signal received by the signal reception circuit 47 and displays a current location mark MAa superimposed on a spot corresponding to the current location in the in-store map image ARb. Thus, it is easy for the customer to ascertain a positional relation between his/her current position and the position of the commodity exhibition shelf which is a target. The processor 41 may update a display position of the current location mark MAa as the customer moves. In this way, it is possible to reliably guide the customer to the commodity exhibition shelf which is a target.

The customer confirming the shelf instruction screen SCe touches the “stocktaking start” button BTg or the “return” button BTh. That is, after the customer moves to the position of the actual commodity exhibition shelf corresponding to the scan shelf position mark MAb, the customer touches the “stocktaking start” button BTg to start stocktaking. If the commodity exhibition shelf indicated by the scan shelf position mark MAb is far away from a current position of the customer, the customer may want to do shopping during the movement to the position of the actual commodity exhibition shelf in some cases. Then, the customer who wants to do the shopping first touches the “return” button BTh to postpone the stocktaking.

In ACT 418, the processor 41 displaying the shelf instruction screen SCe confirms whether the “stocktaking start” button BTg is touched. If the “stocktaking start” button BTg is not touched, the processor 41 determines NO in ACT 418 and the process proceeds to ACT 419. In ACT 419, the processor 41 confirms whether the “return” button BTh is touched. If the “return” button BTh is not touched, the processor 41 determines NO in ACT 419 and the process returns to ACT 418. Here, the processor 41 waists for a touch of the “stocktaking start” button BTg or a touch of the “return” button BTh in ACT 418 and ACT 419.

If the “stocktaking start” button BTg is touched in the waiting state of ACT 418 and ACT 419, the processor 41 determines YES in ACT 418 and the process proceeds to ACT 420. In ACT 420, the processor 41 activates the camera 45 and displays a shelf position scanning screen on the touch panel 44.

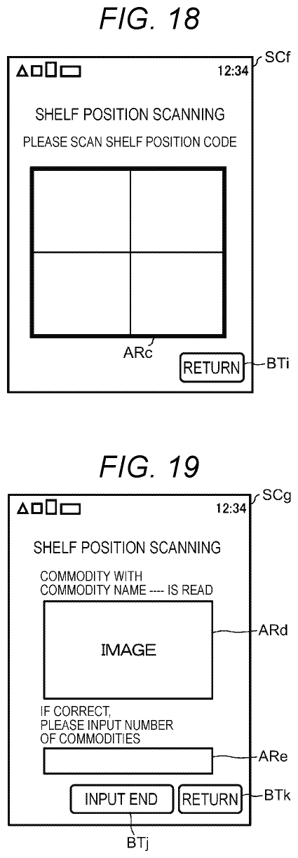

FIG. 18 illustrates an example of the shelf position scanning screen SCf. On the shelf position scanning screen SCf, as illustrated, an image indicating a reading region ARc of a 2-dimensional code and an image of a “return” button BTi are displayed.

The customer confirming the shelf position scanning screen SCf holds up the lens of the camera 45 embedded in the shopping support device 40 so that the shelf position code installed on the commodity exhibition shelf for entrance fits within the reading region ARc. The customer who ends the stocktaking touches the “return” button BTi.

In ACT 421, the processor 41 displaying the shelf position scanning screen SCf confirms whether the shelf position code is read by the camera 45. If the shelf position code is not read, the processor 41 determines NO in ACT 421 and the process proceeds to ACT 422. In ACT 422, the processor 41 confirms whether the “return” button BTi is touched. If the “return” button BTi is not touched, the processor 41 determines NO in ACT 422 and the process returns to Act 421. Here, the processor 41 waits for reading of the shelf position code or a touch of the “return” button BTi in ACT 421 and ACT 422.

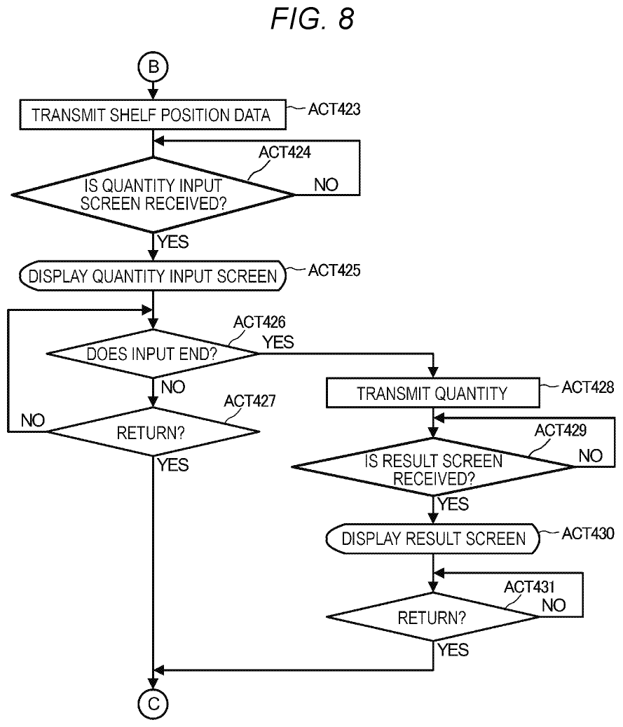

If the lens of the camera 45 is held up to a data code of a 2-dimensional code system in the waiting state of ACT 421 and ACT 422, the processor 41 analyzes data coded with the data code from an image of the data code captured by the camera 45. Then, the processor 41 confirms whether the read data code is the shelf position code. If the data code is the shelf position code, the processor 41 determines YES in ACT 421 and the process proceeds to ACT 423 of FIG. 8.

In ACT 423, the processor 41 transmits the shelf position data indicating the shelf position which is the data obtained by analyzing the read shelf position code to the management server 20. Thereafter, in ACT 424, the processor 41 waits for reception of a quantity input screen as response data from the management server 20.

If the processor 21 of the management server 20 receives the shelf position data in the waiting state of the subsequent instruction of ACT 205 to ACT 207 illustrated in FIG. 11, the processor 21 determines YES in ACT 206 and the process proceeds to ACT 213.

In ACT 213, the processor 21 generates the quantity input screen so that the customer inputs the number of commodities exhibited in the commodity exhibition shelf indicated by the shelf position data. The processor 41 can include commodity names or commodity images of the commodities described in the region 75 of the target store data file 232 in the quantity input screen so that the customer performing stocktaking confirms the commodities.

In ACT 214, the processor 41 transmits the generated quantity input screen to the shopping support device 40 which is a shelf position data transmission source. Thereafter, in ACT 215, the processor 41 waits for reception of a quantity input result from the shopping support device 40.

The processor 41 of the shopping support device 40 receives the quantity input screen from the management server 20 in the reception waiting state of the quantity input screen of ACT 424 illustrated in FIG. 8, the processor 41 determines YES in ACT 422 and the process proceeds to ACT 425. In ACT 425, the processor 41 displays the received quantity input screen on the touch panel 44.

FIG. 19 illustrates an example of a quantity input screen SCg. On the quantity input screen SCg, as illustrated, a message indicating a commodity name of a commodity to be stocked in the commodity exhibition shelf and a commodity image ARd of the commodity based on the read shelf position code are displayed. Further, on the quantity input screen SCg, an image of an input region ARe for inputting the number of commodities, an image of an “input end” button BTj, and an image of a “return” button BTk are displayed. If the image of the input region ARe is touched, the processor 41 can display a software keyboard for input a numeral value or a pull-down menu for selecting a numeral value.

The customer confirming the commodity name or a commodity image of the quantity input screen SCg counts the number of commodities exhibited in the commodity exhibition shelf, touches the image of the input region ARe, and inputs a numeral value indicating the counted number into the input region ARe. Then, after the numerical value is input, the customer touches the “input end” button BTj. If the displayed commodity does not match the commodity exhibition shelf in which the shelf position data is read, the customer touches the “return” button BTk to re-scan the shelf position data.

In ACT 426, the processor 41 displaying the quantity input screen SCg confirms whether the “input end” button BTj is touched. If the “input end” button BTj is not touched, the processor 41 determines NO in ACT 426 and the process proceeds to ACT 427. In ACT 427, the processor 41 confirms whether the “return” button BTk is touched. If the “return” button BTk is not touched, the processor 41 determines NO in ACT 427 and the process returns to ACT 426. Here, the processor 41 waits for a touch of the “input end” button BTj or a touch of the “return” button BTk in ACT 426 and ACT 427.

If the “return” button BTk is touched in the waiting state of ACT 426 and ACT 427, the processor 41 determines YES in ACT 427 and the process returns to ACT 420 of FIG. 7. That is, the shelf position scanning screen SCf is displayed on the touch panel 44.

If the “input end” button BTj is touched in the waiting state of ACT 426 and ACT 427, the processor 41 determines YES in ACT 426 and the process proceeds to ACT 428.

In ACT 428, the processor 41 transmits the input numerical value as a quantity input result indicating the number of commodities to the management server 20. Thereafter, in ACT 429, the processor 41 waits for reception of a result screen which is as response data from the management server 20.

If the processor 21 of the management server 20 receives the quantity input result from the shopping support device 40 in the reception waiting state of the quantity input result of ACT 215 illustrated in FIG. 11, the processor 21 determines YES in ACT 215 and the process proceeds to ACT 216.

In ACT 216, the processor 21 updates the number on display in the region 75 of the target store data file 232 to the number of actually displayed commodities indicated by the received quantity input result. The processor 21 also updates the number in stock in the region 75 of the target store data file 232 based on a quantity difference before and after the updating of the number of exhibitions. Further, the processor 21 updates the stocktaking date and time in the region 75 of the target store data file 232 to the current date and time as clocked by the watch 24. Then, the processor 41 stores the target store data file 232 updated in this way instead of the store data file 232 corresponding to the auxiliary storage device 23. In this way, the processor 21 can register commodity exhibition position information including data related to the number of commodities exhibited at the commodity exhibition position in the auxiliary storage device 23.

Further, the processor 21 transmits the data of the region 75 in the target store data file 232 updated in ACT 217 to the store server 11 included in the store system 10 of the corresponding store. The store server 11 receiving the updated data of the region 75 updates the content of a commodity database (not illustrated) to the received data.

Thus, the commodity database included in the store server 11 of the store system is synchronized with the data of the region 75 in the store data file 232 of the corresponding store stored in the auxiliary storage device 23 of the management server 20.

In ACT 218, the processor 21 grants remuneration points for the stocktaking work of the customer. That is, the processor 41 adds the regulated remuneration points such as one point to the point information stored in the field F63 of the data record 60 associated with the customer of the member database 231.

Thereafter, in ACT 219, the processor 21 generates a result screen indicating the points acquired by the customer because of the stocktaking. In ACT 220, the processor 21 transmits the generated result screen to the shopping support device 40 of a quantity input result transmission source. Thereafter, the processor 21 returns to the reception waiting state of a subsequent instruction of ACT 205 to ACT 207.

If the processor 41 of the shopping support device 40 receives the result screen from the management server 20 in the reception waiting state of the result screen of ACT 429 illustrated in FIG. 8, the processor 41 determines YES in ACT 429 and the process proceeds to ACT 430. In ACT 430, the processor 41 displays the received result screen on the touch panel 44.

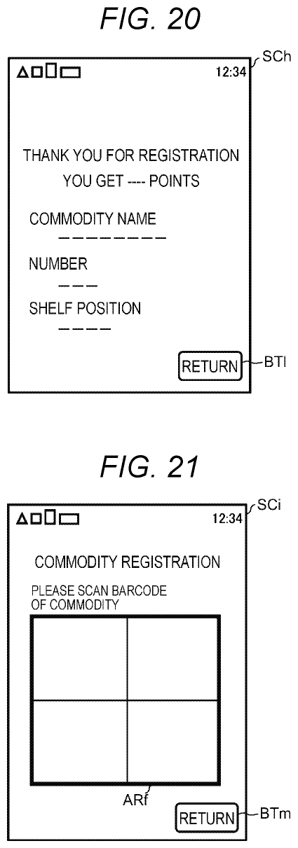

FIG. 20 illustrates an example of a result screen SCh. On the result screen SCh, as illustrated, an image indicating the points which the customer gets because of the stocktaking and an image indicating the commodity name, the number of commodities, and the shelf position which are information acquired from the stocktaking work of the customer are displayed. Further, an image of a “return” button BTl is displayed on the result screen SCh. The customer confirming the result screen SCh touches the “return” button BTl.

In ACT 431, the processor 41 displaying the result screen SCh waits for a touch of the “return” button BTl.

If the “return” button BTl is touched in the waiting state of ACT 431, the processor 41 determines YES in ACT 431 and the process returns to ACT 420 of FIG. 7. That is, the shelf position scanning screen SCf is displayed on the touch panel 44.

Conversely, if the “return” button BTh of the shelf instruction screen SCe is touched in the waiting state of ACT 418 and ACT 419 of FIG. 7, the processor 41 determines YES in ACT 419 and the process proceeds to ACT 432. If the “return” button BTi of the shelf position scanning screen SCf is touched in the waiting state of ACT 421 and ACT 422, the processor 41 determines YES in ACT 422 and the process proceeds to ACT 432.

In ACT 432, the processor 41 determines whether the customer is doing shopping. The processor 41 can determine whether the customer is doing shopping depending on whether transmission of a stocktaking start command to the management server 20 is completed.

If the stocktaking start command is not transmitted to the management server 20, the processor 41 determines that the customer is not doing shopping and determines NO in ACT 432. In this case, the processor 41 causes the process to proceed to ACT 407 of FIG. 6. That is, the processor 41 displays the check-in completion screen SCc on the touch panel 44.

Conversely, if the stocktaking start command is transmitted to the management server 20, the processor 41 determines that the customer is doing shopping and determines YES in ACT 432, and the process proceeds to ACT 433.

In ACT 433, the processor 41 transmits a stocktaking end command to the management server 20. Thereafter, the processor 41 causes the process to proceed to ACT 410 of FIG. 6. That is, the processor 41 displays the registration list screen SCd on the touch panel 44.

If the processor 21 of the management server 20 receives the stocktaking end command from the shopping support device 40 in the reception waiting state of a subsequent instruction of ACT 205 to ACT 207 illustrated in FIG. 11, the processor 21 determines YES in ACT 207. If the processor 21 determines YES, the process illustrated in FIG. 11 ends.

If the “commodity scanning” button BTe of the registration list screen SCd is touched in the waiting state of ACT 411 to ACT 413 during the shopping, the processor 21 of the shopping support device 40 determines YES in ACT 411 and the process proceeds to ACT 434 of FIG. 9. In ACT 434, the processor 41 activates the camera 45 and displays a registration screen on the touch panel 44.

FIG. 21 illustrates an example of a registration screen SCi. On the registration screen Sci, as illustrated, an image indicating a reading region ARf of a 2-dimensional code and an image of a “return” button BTm are displayed.

The customer starting shopping holds up the lens of the camera 45 to the barcode so that the barcode attached to a purchased commodity fits within the reading region ARf if the customer puts the purchased commodity in a container such as a shopping basket or a shopping cart. Then, the barcode is scanned by the camera 45. The barcode includes a commodity code of the commodity being purchased. The customer who wants to stop registering the commodities touches the “return” button BTm.

In ACT 435, the processor 41 displaying the registration screen SCi confirms whether the data code is read by the camera 45. If the data code is not read, the processor 41 determines NO in ACT 435 and the process proceeds to ACT 436. In ACT 436, the processor 41 confirms whether the “return” button BTm is touched. If the “return” button BTm is not touched, the processor 41 determines NO in ACT 436 and the process returns to ACT 435. Here, the processor 41 waits for reading of the data code or a touch of the “return” button BTm in ACT 435 and ACT 436.

If the “return” button BTm is touched in the waiting state of ACT 435 and ACT 436, the processor 41 determines YES in ACT 436 and the process returns to ACT 410 of FIG. 6. Thus, the display of the touch panel 44 returns to the registration list screen SCd.

Conversely, if the data code is read by the camera 45 in the waiting state of ACT 435 and ACT 436, the processor 41 determines YES in ACT 435 and the process proceeds to ACT 437. In ACT 437, the processor 41 analyzes the data code. In ACT 437, the processor 41 confirms whether the data code is the commodity code. If the data code is the commodity code, the processor 41 determines YES in ACT 437 and the process proceeds to ACT 438. In ACT 438, the processor 41 registers the commodity indicated by the commodity code as a purchased commodity. The process proceeds to ACT 410 of FIG. 6 and the processor 41 displays the registration list screen SCd on the touch panel 44.

Specifically, the processor 41 transmits the commodity code to the store system 10 through wireless communication. For example, the processor 41 controls the wireless unit 46 such that the data of the commodity code is transmitted to the store system 10 via the in-store LAN using a parameter set in the store setting table 432. In this case, the data of the commodity code is received at the access point 15 to be obtained by the virtual POS server 12. Alternatively, the processor 41 controls the communication interface 48 such that the data of the commodity code is transmitted to the store system 10 via the management server 20 using a parameter set in the store setting table 432. In this case, the data of the commodity code is received by the communication server 13 to be obtained by the virtual POS server 12.

The virtual POS server 12 obtaining the data of the commodity code acquires commodity data such as a commodity name and a price of a commodity specified with the commodity code from the commodity database of the store server 11. Alternatively, the virtual POS server 12 acquires the commodity data from a local commodity database obtained by copying the commodity database of the store server 11 to the virtual POS server 12. The virtual POS server 12 generates sales data of the purchased commodities based on the acquired commodity data and registers the sales data in a commodity registration table in which an identification code of the shopping support application program 431 in the shopping support device 40 is set. The virtual POS server 12 generates data of the registration list screen SCd based on the data registered in the commodity registration table and transmits the data to the shopping support device 40. Even in this case, the data of the registration list screen SCd is transmitted to the shopping support device 40 via the access point 15 or the management server 20. Thus, the processor 41 of the shopping support device 40 updates the registration list screen SCd displayed on the touch panel 44.

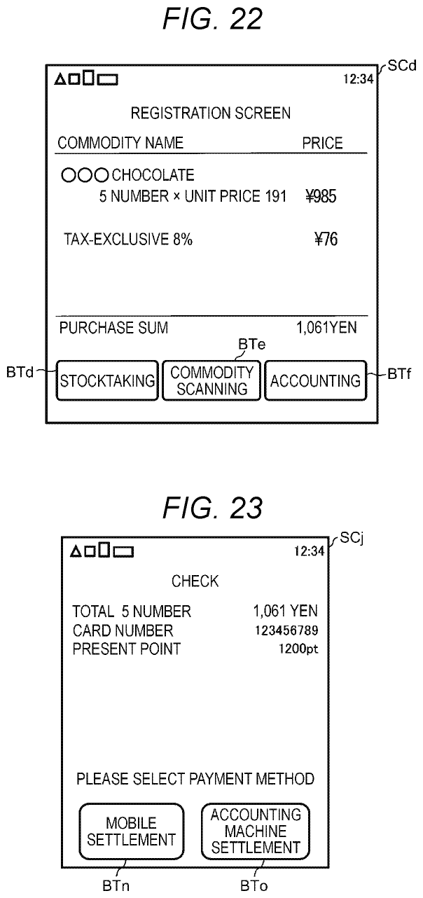

FIG. 22 illustrating an example of the registration list screen SCd updated in this way.

In the waiting state of ACT 435 and ACT 436, there is a possibility of the customer reading the exit data code 52 with the camera 45 other than the commodity code. Thus, if the data code read with the camera 45 is not the commodity code, the processor 41 determines NO in ACT 437 and the process proceeds to ACT 439. In ACT 439, the processor 41 confirms whether the exit data code 52 is read. If the processor 41 confirms that the exit data code 52 is read, the processor 41 determines YES in ACT 439 and the process proceeds to ACT 440. In ACT 440, the processor 41 gives an unaccounted warning. For example, the processor 41 displays an unaccounted warning screen on the touch panel 44 and gives a warning indicating that accounting is not completed. In ACT 440, the processor 41 controls the wireless unit 46 such that a warning signal is sent toward the store server 11. Through this control, the warning signal is wirelessly transmitted from the wireless unit 46. The warning signal is transmitted via the wireless LAN, is received by the access point 15, and is sent to the store server 11. For example, the store server 11 receiving the warning signal outputs the warning signal to a client terminal at which there is an operator who is a salesperson and a warning of an unaccounted error is issued from the client terminal.

The process returns to ACT 410 of FIG. 6 and the processor 41 controlling the transmission of the warning signal displays the registration list screen SCd on the touch panel 44.

If the “accounting” button BTf is touched in the waiting state of ACT 411 to ACT 413 of FIG. 6, the processor 41 determines YES in ACT 413 and the process proceeds to ACT 441 of FIG. 10. In ACT 441, the processor 41 displays an accounting screen on the touch panel 44.

FIG. 23 illustrates an example of the accounting screen SCj. On the accounting screen SCj, as illustrated, a total number and a total sum due for purchased commodities are displayed. The total number and the total sum due are values calculated from the data of the commodity registration table in which the identification code of the shopping support application program 431 in the shopping support device 40 is set in the virtual POS server 12. On the accounting screen SCj, a “mobile settlement” button BTn for selecting mobile settlement and an “accounting machine” button BTo for selecting accounting machine settlement are displayed as payment methods.

If the fact that the store is a store in which the mobile settlement is not adopted is described in the setting information based on the entrance data code 51 stored in the store setting table 432, the button BTg is not displayed. Alternatively, the button BTg is not activated. Further, only when a card number of a points card is registered in the shopping support device 40, the card number and accumulated points up to the present are displayed on the accounting screen SCj. The accumulated points can be acquired by inquiring of the management server 20 or can be set to the point information set in the field F63 of the corresponding data record 60 of the member database 231 in the virtual POS server 12.

The customer confirming the accounting screen SCj touches the “mobile settlement” button BTn if the customer pays a price of the purchased commodities with the mobile settlement. The customer performing the settlement with the accounting machine 14 touches the “accounting machine settlement” button BTo.

In ACT 442, the processor 41 controlling the display of the accounting screen SCj waits for a selection of the mobile settlement or a selection of the accounting machine settlement. That is, the processor 41 waits for a touch of the “mobile settlement” button BTn or a touch of the “accounting machine settlement” button BTo. If the “accounting machine settlement” button BTo is touched, that is, the accounting machine settlement is selected, the processor 41 determines YES in ACT 442 and the process proceeds to ACT 443. In ACT 443, the processor 41 performs an accounting machine settlement process. Conversely, if the “mobile settlement” button BTn is touched, that is, the mobile settlement is selected, the processor 41 determines NO in ACT 442 and the process proceeds to ACT 444. In ACT 444, the processor 41 performs a mobile settlement process.

Since both the accounting machine settlement process and the mobile settlement process are known processes, the accounting machine settlement process and the mobile settlement process will not be described in detail. If a card number of a points card is registered in the shopping support device 40, for example, points calculated with regard to a purchase sum are added to the cumulative points.

If the accounting machine settlement process or the mobile settlement process ends, the processor 41 causes the process to proceed to ACT 445. In ACT 445, the processor 41 displays a check-output screen on the touch panel 44.

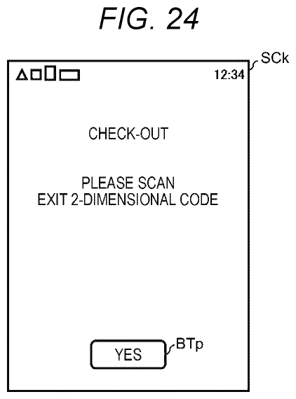

FIG. 24 illustrates an example of a check-out screen SCk. On the check-out screen SCk, as illustrated, an image of a “YES” button BTp is displayed along with a message giving an instruction to scan a 2-dimensional code for exit. The customer confirming the check-out screen SCk touches the “YES” button BTp.

If the “YES′ button BTp of the check-out screen SCk is detected to be touched with a signal from the touch panel 44, the processor 41 displays a camera screen on the touch panel 44 in ACT 446. The camera screen is the same except that “check-in” of a title of the camera screen SCb in entrance is substituted with “check-out”. The customer confirming the camera screen holds up the lens of the camera 45 embedded in the shopping support device 40 to the exit data code 52 so that the exit data code 52 prepared at an exit of the store fits within a reading area ARa.

In ACT 447, the processor 41 displaying the camera screen SCb waits for reading of the data code of the 2-dimensional code system by the camera 45. If the data code of the 2-dimensional code system fits within the reading region ARa, the processor 41 determines that the data code is read. In ACT 447, the processor 41 determines YES and the process proceeds to ACT 448.

In ACT 448, the processor 41 analyzes the data coded with the data code from an image of the data code captured by the camera 45. In ACT 448, the processor 41 determines whether the read data code is the exit data code 52.

If the data code read by the camera 45 is not the exit data code 52, the processor 41 determines NO in ACT 448 and the process returns to ACT 447. The processor 41 waits for reading of the data code of the 2-dimensional code system by the camera 45 again.

If the data code read by the camera 45 is the exit data code 52, the processor 41 determines YES in ACT 448 and the process proceeds to ACT 449. In ACT 449, the processor 41 clears the setting information described in the store setting table 432.

Then, the processor 41 ends the information processing.

As described above, a stocktaking system 1 includes s shopping support device 40 (serving as a customer terminal operated by a customer in a store) and a management server 20 (serving as a data processing device) that manages and/or tracks inventory of commodities at the store. The processor 41 of the shopping support device 40 provides functions of an announcement unit, a reception unit, and a transmission unit. The processor 21 of the management server 20 provides functions of a designation unit and a registration unit. That is, the processor 41 announces the stocktaking of commodities in the store to the management server 20 in response to an operation of a customer on the touch panel 44, receives a designation of a commodity exhibition position at which stocktaking was performed from the management server 20, receives an input of data as to the number of commodities exhibited at the commodity exhibition position through an operation of the customer on the touch panel 44, and transmits the input data to the management server 20 using the wireless unit 46 or the communication interface 48. The processor 21 of the management server 20 designates the commodity exhibition position at which the stocktaking was performed to the shopping support device 40 in response to the announcement from the shopping support device 40, receives the data from the shopping support device 40 related to at least the number of commodities exhibited at the commodity exhibition position, and registers commodity exhibition position information including the data from the shopping support device 40.

In this way, no staff member or the like is necessary for the stocktaking work since a customer visiting the store performs the stocktaking work. Thus, it is possible to reduce the stocktaking work requirements on the staff of the store.

In the stocktaking system according to one embodiment, the processor 21 of the management server 20 selects the commodity exhibition position at which a particular customer performs stocktaking from among a plurality of commodity exhibition positions at which stocktaking has to be performed based on a predetermined condition or conditions such as a purchase history, an age, a gender, and the like of the customer.

Accordingly, it is possible to prevent assignment of stocktaking of commodities which are not appropriate for the customer.

In the stocktaking system according to one embodiment, the management server 20 further includes the member database 231 serving as storage unit for storing history information of commodities previously purchased by the customer. The processor 21 selects the commodity exhibition position to be designated based on the stored history information.

Accordingly, the stocktaking of the commodities previously purchased by the customer can be performed. Thus, for the customer, it may be easier to determine the position at which the customer needs to perform the stocktaking. For the store, the customer can be also guided to the position of previously purchased commodities, which helps to promote repurchase of such commodities by the customer.

In the stocktaking system according to one embodiment, the processor 21 of the management server 20 functions as granting unit for granting a privilege or customer benefit via the shopping support device 40 which is the transmission source of the data related to the number of commodities exhibited at the commodity exhibition position.

In this way, a benefit can be granted to the customer for the stocktaking that is performed by the customer, and thus the customer is motivated to perform the stocktaking. The granted benefit may be referred to a reward, a task reward, a completion reward, a points award, a task payment or the like.

The processor 21 of the management server 20 functions as reception unit, determination unit, transmission unit, and registration unit. That is, the processor 21 of the management server 20 receives an announcement about or request for stocktaking of commodities in a store through the communication interface 25 from the shopping support device 40 which is a dedicated handy terminal serving as a staff terminal operated by a staff such as a salesperson of the store or is a customer terminal operated by a customer who is a customer in the store. When the announcement/request is received, the processor 21 determines whether the announcement is from the shopping support device 40. If the announcement is from a shopping support device 40, the processor 21 determines a commodity exhibition position (display location) at which stocktaking should be performed by the customer based on some predetermined condition or combination of conditions such as the requesting customer's purchase history, age, gender, or the like which may have been registered in the member database 231 and transmits the selected commodity exhibition position for the stocktaking to be performed to the shopping support device 40 (customer terminal) through the communication interface 25. The processor 21 receives data from the shopping support device 40 which is related to the number of commodities presently on display at the commodity exhibition position. Such data is received through the communication interface 25, and the processor 21 registers the received data in the store data file 232 in association with commodity exhibition position.

In this way, since someone other than a staff member or the like, such as a customer visiting the store, can perform stocktaking work, it is possible to reduce a stocktaking work amount of the store staff.

Certain example embodiments of a stocktaking system has been described above, but the present disclosure is not limited thereto.

According to one embodiment, the management server 20 functions as a data processing device. In a store system 10 that is not connected to a management server 20, the store server 11 may function as the data processing device instead. In this case, the store server 11 includes the member database 231 and the store data file 232. The store data file 232 may not need to include a company code and a store code.

According to the one embodiment, an update target shelf position at which a customer is requested to perform stocktaking can be selected by first narrowing down the possible update target shelf positions based on the member purchase history information. The update target shelf position may be narrowed down based on a condition or conditions such as an age or a gender of a customer, a present location of the customer within the store or other information besides, or in addition to, the customer's commodity purchase history.

Further, according to the one embodiment, any customer who makes an application by touching the “stocktaking” button BTc or BTd can perform stocktaking at anytime. However, in some examples, various limitations such as a limitation on the number of times a customer may perform stocking, a required duration of membership in a points-based loyalty program, or an age limitation can be imposed on the possible stocktaking by the customer.

According to the one embodiment, a shelf position (display location) can be associated in advance with particular commodities, and thus a customer may not necessarily need to scan commodity codes when scanning a shelf position code and may instead just input the number of commodities at the display location. If the shelf positions are not pre-associated with the commodities or the commodities are not at the intended display location, the customer may be requested to scan the commodity codes in addition to the shelf position code. In this case, an additional benefit to be granted to the customer can also be provided.

According to the one embodiment, the update target shelf position is designated in accordance with the shelf position of the commodity exhibition shelf. The update target position may include the number of stages (individual shelves) of a display shelf on which commodities are exhibited. For example, by displaying information indicating “the second shelf from the top” for commodities exhibited on the second shelf from the top of a commodity exhibition shelf along with the scan shelf position mark MAb, it is possible to notify a customer of a particular exhibition location of the commodities more accurately.

According to the one embodiment, a privilege or benefit can be granted for each registration of one commodity even if a plurality of commodities are exhibited on a commodity exhibition shelf at a designated shelf position. If the plurality of commodities are exhibited in the commodity exhibition shelf at the designated shelf position, a benefit may be granted under the condition that registration of all the commodities at the shelf position is completed. Alternatively, when a benefit may be granted for each individual registration of a commodity and all the commodities are registered, a bonus benefit or privilege may be granted.

According to the one embodiment, the in-store map image is a 2-dimensional image. The in-store map image may be a 3-dimensional image in some examples.

According to the one embodiment, a beacon is used for recognizing a current location of the shopping support device 40. The technology for recognizing the current location is not limited to use of a beacon. For example, the current location of the shopping support device 40 may be recognized using global positioning system (GPS) or the like.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stocktaking system, comprising:
a customer terminal to be carried by a customer in a store, the customer terminal including:
a first processor,
a touch panel display screen,
a wireless communication interface, and
a camera; and
a store server for tracking commodity inventory at the store, the store server including:
a second processor,
a communication interface configured to communicate with the wireless communication interface, and
a data storage device, wherein
the first processor is configured to:
display a customer stocktaking request button on the touch panel display screen, and
send a stocktaking request, via the wireless communication interface, to the store server when the customer presses the stocktaking request button,
the second processor is configured to:
transmit a stocktaking location via the communication interface in response to the stocktaking request, and
the first processor is further configured to:
receive the stock taking location via the wireless communication interface,
indicate the stocktaking location on the touch panel display screen,
receive a data input via the camera indicating the total number of a commodity at the stocktaking location, and
transmit, via the wireless communication interface, the data input to the store server.

2. The stocktaking system according to claim 1, wherein the second processor is further configured to select the stocktaking location based on a prior purchase history of the customer.

3. The stocktaking system according to claim 2, wherein the prior purchase history is stored in the data storage device.

4. The stocktaking system according to claim 1, wherein the second processor is further configured to transmit a completion reward value to the customer terminal along with the stocktaking location.

5. The stocktaking system according to claim 1, wherein the stocktaking location is indicated on a store map.

6. The stocktaking system according to claim 1, wherein the customer terminal is a cellular phone.

7. The stocking system according to claim 1, wherein
the data storage device stores a current stock number for the commodity at the stocktaking location, and
the second processor is configured to update the current stock number based on the data input received from the customer terminal.

8. A store server for tracking commodity inventory at a store, the store server comprising:
a processor;
a data storage unit; and
a communication interface configured to communicate with a customer terminal running a shopping support application, wherein
the processor is configured to:
receive, via the communication interface, a stocktaking request from the shopping support application,
transmit a stocktaking location via the communication interface to the customer terminal in response to the stocktaking request,
receive, via the communication interface, a data input from the shopping support application indicating the total number of a commodity at the stocktaking location, and
update a current stock number stored in the data storage unit for the commodity at the stocktaking location based on the received data input.

9. The store server according to claim 8, wherein the processor is further configured to select the stocktaking location based on a prior purchase history of the customer.

10. The store server according to claim 9, wherein the prior purchase history is stored in the data storage unit.

11. The store server according to claim 8, wherein the processor is further configured to transmit a completion reward value to the customer terminal along with the stocktaking location.

12. The store server according to claim 8, wherein the stocktaking location is indicated as coordinates on a store map.

13. The store server according to claim 8, wherein the communication interface is connected to a wireless access point.

14. The store server according to claim 8, wherein the processor is further configured to provide a virtual point-of-sale terminal permitting registration of commodities via the customer terminal for a sales transaction.

15. A non-transitory computer-readable storage medium storing program instructions which when executed by a processor of a store server causes the store server to perform a method comprising:
receive, via a communication interface, a stocktaking request from a shopping support application running on a customer terminal;
transmit a stocktaking location via the communication interface to the customer terminal in response to the stocktaking request;
receive, via the communication interface, a data input from the shopping support application indicating the total number of a commodity at the stocktaking location; and
update a current stock number stored in a data storage device for the commodity at the stocktaking location based on the received data input.

16. The non-transitory computer-readable storage medium according to claim 15, wherein the program instructions further cause the store server to select the stocktaking location based on a prior purchase history of the customer.

17. The non-transitory computer-readable storage medium according to claim 15, wherein the program instructions further cause the store server to transmit a completion reward value to the customer terminal along with the stocktaking location.

18. The non-transitory computer-readable storage medium according to claim 15, wherein the completion reward value is a discount amount on a commodity for sale at the store.

19. The non-transitory computer-readable storage medium according to claim 15, wherein the completion reward value is a points total for a points-based customer loyalty program.

20. The non-transitory computer-readable storage medium according to claim 15, wherein the program instructions further cause the store server to provide a virtual point-of-sale terminal permitting registration of commodities via the customer terminal for a sales transaction.
